(19) United States
(12) Patent Application Publication
(10) Pub. No.: US 2017/0022901 A1
(43) Pub. Date: Jan. 26, 2017

(54) Turbine rotor cooling air static collector

(71) Applicant: John A. Orosa, Palm Beach Gardens, FL (US)

(72) Inventor: John A. Orosa, Palm Beach Gardens, FL (US)

(21) Appl. No.: 15/131,110

(22) Filed: Apr. 18, 2016

Related U.S. Application Data
(60) Provisional application No. 62/195,512, filed on Jul. 22, 2015.

(51) Int. Cl. F02C 7/18; F02C 3/04

(52) U.S. Cl. CPC F02C 7/18; F02C 3/04; F05D 2260/20

(57) ABSTRACT

A gas turbine engine with an air cooled turbine component in which spent cooling air from the turbine component is routed through a rotor disk and into a static vaned diffuser on a static part of the engine so that the spent cooling air can be discharged into the combustor instead of into the turbine hot gas stream. The static vaned diffuser includes de-swirling vanes that de-swirl the flow coming off of the rotor and then diffuses the de-swirled air to increase a pressure for discharge into the combustor.

### CROSS-REFERENCE TO RELATED APPLICATIONS

This application claims the benefit to U.S. Provisional Application 62/195,512 filed on Jul. 22, 2015 and entitled TURBINE ROTOR COOLING FLOW STATIC COLLECTOR.

### GOVERNMENT LICENSE RIGHTS

This invention was made with Government support under contract number DE-FE0023975 awarded by Department of Energy. The Government has certain rights in the invention.

### BACKGROUND OF THE INVENTION

Field of the Invention

The present invention relates generally to a gas turbine engine, and more specifically to a gas turbine engine with rotor cooling in which the spent cooling air is discharged from a rotating rotor and collected in a static vaned diffuser so that the spent cooling air can be discharged into a combustor.

Description of the Related Art Including Information Disclosed Under 37 CFR 1.97 and 1.98

In an industrial gas turbine engine, cooling air is used in the turbine to cool both stationary vanes and rotating blades. Cooling air for the air cooled turbine airfoils is bled off from the compressor and passed through internal cooling circuits of the airfoils. The airfoils are cooled using impingement cooling, convection cooling, or film cooling. The spent cooling air is typically discharged back into the turbine hot gas stream through film or exit cooling holes in the airfoils. Thus, the work used to compress the cooling air is lost when the spent cooling air is discharged into the turbine hot gas stream without performing any additional work on the turbine.

### BRIEF SUMMARY OF THE INVENTION

A gas turbine engine with an air cooled turbine rotor component in which the spent cooling air is eventually discharged into a combustor along with the compressed air from a compressor in order to reuse the spent cooling air. The spent cooling air from the air cooled turbine rotor component is passed through the rotor using cooling air tubes that include injector nozzles that discharge the spent cooling air as an annular jet in the direction opposite to rotor rotation in order to minimize the circumferential flow angle (swirl) of the spent cooling air. The free annular jet then traverses across a cavity of required minimum axial and radial clearances to be collected, deswirled and diffused in a static annular vaned diffuser. The inlet of the vaned diffuser has an outer flow path segment designed to direct the spent cooling air into the vaned diffuser as the cooling air moves radially outward due to the injector nozzle radial angle and the centrifugal forces generated by the swirling flow. Once the spent cooling air is deswirled and diffused in the vaned diffuser, it is ducted to the compressor exit diffuser and injected into the main flow which travels downstream to be used in the combustor of the engine. The injector nozzles diverge in a top view to form a nearly circumferentially continuous annular jet and converge in a side view to accelerate the spent cooling air to minimize the rotor/stator cavity pressure that drives leakage flow into the turbine main flow path.

The air cooled turbine component is a turbine rotor blade but could also be a turbine rotor disk. The discharge of spent cooling air from a rotor to a static part of the engine is intended for use in an industrial gas turbine engine for electrical power production, but could be used in an aero engine for aircraft propulsion. Either engine can have the efficiency increased by discharging spent cooling air into the combustor instead of directly into the hot gas stream passing through the turbine.

The spent cooling air from the stator vanes and the rotor blades can then be discharged into the combustor as preheated compressed air to be burned with a fuel. The spent cooling air from stationary vanes can be easily captured and channeled to the combustor. However, the spent cooling air from the rotor must be discharged from a rotating part into an intermediate cavity to then be collected and routed through a static diffuser for use in the combustor.

### BRIEF DESCRIPTION OF THE SEVERAL VIEWS OF THE DRAWINGS

FIG. 1 shows a cross sectional view of a first stage of a turbine with a stationary vane and a rotor blade in which spent cooling air from the rotor is collected in a static part and de-swirled in a diffuser of the present invention.

FIG. 2 shows a top view of three of the injector nozzles in the rotor from FIG. 1 according to the present invention.

FIG. 3 shows a side view of one of the injector nozzles in the rotor from FIG. 1 according to the present invention.

### DETAILED DESCRIPTION OF THE INVENTION

The present invention is a gas turbine engine with turbine rotor disk cooling in which the spent turbine rotor cooling air is discharged from the rotating rotor as a free annular jet and collected in a static vaned diffuser that feeds the spent cooling air into the main flow entering the engine compressor exit diffuser. The main flow and spent cooling air then travel downstream to be used in the combustor of the engine. Injector nozzles on the rotor cooling air tubes discharge the spent cooling air as an annular jet in the direction opposite to rotor rotation in order to minimize the circumferential flow angle (swirl) of the spent cooling air. The inlet of the vaned diffuser has an outer flow path segment designed to direct the spent cooling air into the vaned diffuser as the cooling air moves radially outward due to the injector nozzle radial angle and the centrifugal forces generated by the swirling flow. The jet flows away from a seal and functions as an ejector to reduce the seal upstream pressure and leakage into the turbine flow path. The vaned diffuser includes a number of de-swirling vanes upstream of the diffuser section.

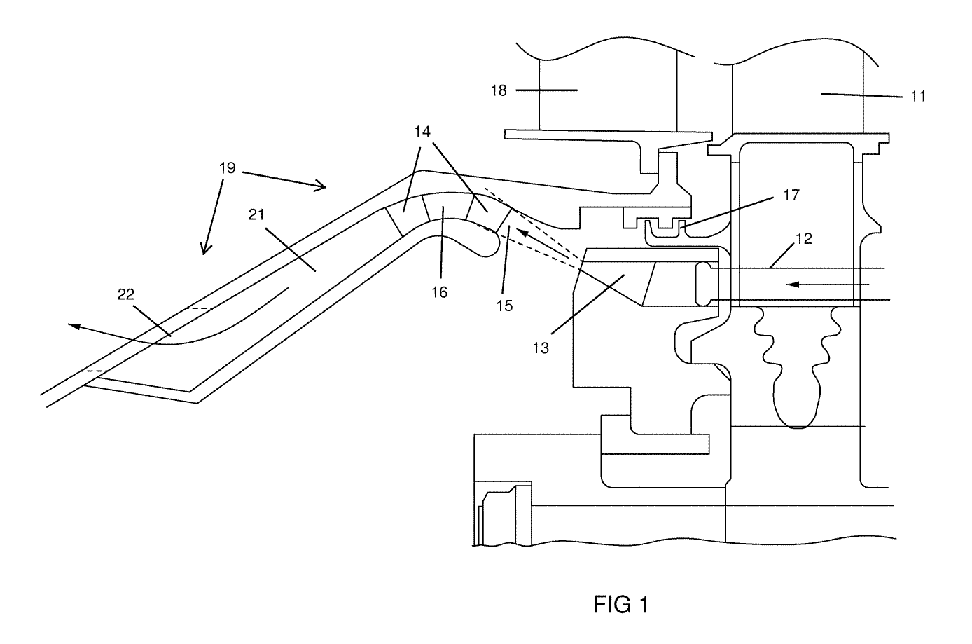

FIG. 1 shows a section of the gas turbine engine between the first stage stator vane 18 and rotor blade 11 of the turbine where spent cooling air from the rotor is discharged into a static part of the engine. The rotor of the first stage rotor blade 11 of the turbine includes a number of cooling air tubes 12 that pass cooling air from one side of the rotor to an opposite side where the spent cooling air is ejected from the rotor as a free annular jet in an outward direction primarily due to the centrifugal forces acting on the swirling air and the orientation of the injector nozzles. The number of cooling air tubes 12 in the rotor could be equal to the number of rotor blades 11 extending from the rotor. The free annular jet traverses across a cavity of required minimum axial and radial clearances needed to avoid clashing between rotating and non-rotating parts. The required radial clearance is typically much smaller than the required axial clearance. This invention takes advantage of the smaller radial clearance by locating the outer wall of the vaned diffuser inlet 15 just outboard of the injector nozzles 13. Upon discharge from the rotor, the spent cooling air quickly centrifuges outboard toward the vaned diffuser inlet 15 outer wall and is guided to enter the vaned diffuser 19. The vaned diffuser includes diffuser inlet 15, deswirl vanes 14, diffuser section 21, and diffuser outlet 22. Minimizing exposure of the free jet to the clearance cavity is important because of the high mixing and entrainment losses the spent cooling air can incur as a free jet. Placement of the vaned diffuser inlet 15 forward and outboard of the injector nozzles 13 by the required minimal clearances insures the minimal free jet distance and that the outboard surface of the free jet is quickly constrained by the outboard wall of the diffuser inlet 15 to protect that jet surface from further mixing and entrainment losses. Once the spent cooling air is captured inside the vaned diffuser 19, it is bounded by the diffuser walls and no longer exists as a free jet. The spent cooling air is then deswirled by deswirl vanes 14, diffused in the diffuser flow path 21 and channeled towards the compressor exit through the vaned diffuser exit 22.

The spent cooling air passing through the rotor (with rotor blade 11) is discharged into the vaned diffuser and flows into a downwardly curved section 16 that can include one or more de-swirl vanes 14 to reduce or eliminate any swirling motion of the cooling air prior to entering the diffuser section 21, the diffuser section 21 being different from the diffuser between the compressor and the combustor of the engine. The spent cooling air from the rotor 11 is de-swirled in the de-swirler vanes 14 and then discharged through a number of diffuser exit holes or slots 22. The spent cooling air can then be passed into a combustor or a main diffuser located at an exit of a main compressor that is then passed into the combustor of the engine. The downwardly curved section 16 is not fundamental to the aerodynamic function of the vaned diffuser 19. It is included in the FIG. 1 cross section because it is often needed to avoid the large combustor and transition duct volumes typically located in the region.

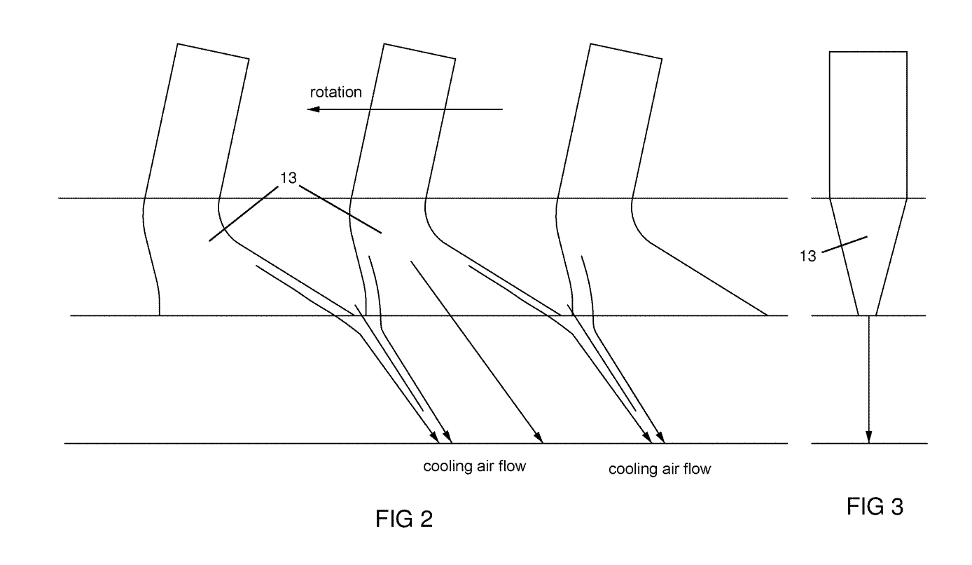

FIG. 2 shows a top view of three of the injector nozzles 13 in FIG. 1 and the angles. FIG. 3 shows a side view of one of the injector nozzles 13. The injector nozzle 13 diverges along the top view while it converges along the side view. The spent cooling air discharged from the nozzles 13 are represented by the arrows in FIGS. 2 and 3. The injector nozzles 13 serve several key functions: 1) they redistribute the spent cooling air in the individual round cooling air tubes to form a circumferentially uniform annular jet that can be more easily collected by the vaned diffuser 19; 2) they direct the cooling air circumferential flow angle to be opposite to the direction of rotor rotation; (this reduces the amount of cooling air swirl angle in the static frame of reference that the deswirl vanes 14 have to remove); 3) they direct the cooling air radial flow angle to best align with the vaned diffuser inlet 15; and 4) they accelerate the cooling air as it leaves the rotor. This is beneficial in several ways: A) it reduces the static pressure in the rotor/stator cavity which is the driver for pushing leakage flow into the main turbine flow path through labyrinth seal 17; B) it further reduces the static pressure on the upstream side of labyrinth seal 17 by acting as an ejector of the local cavity directly upstream of the seal; and C) decreases static frame swirl of the cooling air flow by increasing axial velocity. Note that the injector nozzle radial injection angle seen in this side view is different than seen in FIG. 1. The injector nozzle radial injection angle can be allowed to vary similarly to accommodate various mechanical constraints imposed on the system.

I claim the following:

1: A gas turbine engine comprising:
a compressor to produce a compressed air for a combustor;
a turbine to drive the compressor from a hot gas stream;
an air cooled turbine component;
a turbine rotor disk with a turbine rotor blade extending therefrom;
a turbine stator vane adjacent to the turbine rotor disk;
a cooling air tube extending through the turbine rotor disk to channel spent cooling air from one side of the rotor disk to an opposite side;
the cooling air tube having a nozzle on a discharge end;
a static part of the engine having a static vaned diffuser located adjacent to the cooling air tube nozzle such that spent cooling air discharged from the nozzle will flow into the static vaned diffuser;
the static vaned diffuser including an outboard inlet flow path to constrain and direct the outwardly centrifuging spent cooling flow jet into the vaned diffuser and located just outboard of the nozzles by the minimum required radial anti-clashing clearance; and,
the static vaned diffuser including de-swirling vanes to de-swirl the spent cooling air from the rotating cooling air tube and located axially forward of the nozzles by the minimum required anti-clashing clearance.

2: The gas turbine engine of claim 1, and further comprising:
the cooling air tube nozzle has a slightly radial upward discharge direction.

3: The gas turbine engine of claim 1, and further comprising:
the static vaned diffuser includes a downward curved section.

4: The gas turbine engine of claim 1, and further comprising:
a diffuser located immediately downstream from the de-swirler vanes of the static vaned diffuser.

5: The gas turbine engine of claim 1, and further comprising:
the cooling air tube nozzle has a diverging top view to form a uniform circumferential jet and a converging side view to accelerate the flow.

6: The gas turbine engine of claim 1, and further comprising:
a labyrinth seal formed between the rotor disk and an extension of the static vaned diffuser.

7: The gas turbine engine of claim 6, and further comprising:
a radial clearance between the cooling air tube nozzle and the static vaned diffuser is less than an axial clearance.

8: The gas turbine engine of claim 1, and further comprising:
the turbine rotor disk with the cooling air tube is a first stage turbine rotor disk.

9: The gas turbine engine of claim 5, and further comprising:
the cooling air tube nozzle is angled away from the rotor rotation direction in the top view to reduce the cooling flow swirl angle in the static frame of reference.

10: The gas turbine engine of claim 1, and further comprising:
the number of cooling air tubes is equal to the number of turbine rotor blades on the rotor.
